(19) United States
(12) Patent Application Publication
(10) Pub. No.: US 2009/0099736 A1
(43) Pub. Date: Apr. 16, 2009

(54) Vehicle pre-impact sensing system and method

(76) Inventors: Kevin J. Hawes, Greentown, IN (US); Ronald M. Taylor, Greentown, IN (US); Siddharth S. Rege, Kokomo, IN (US)

Correspondence Address: DELPHI TECHNOLOGIES, INC., M/C 480-410-202, PO BOX 5052, TROY, MI, 48007, US

(21) Appl. No.: 11/973,886

(22) Filed: Oct. 10, 2007

(51) Int. Cl. B60R 21/0134

(52) U.S. Cl. 701/46

(57) ABSTRACT

A vehicle pre-impact sensing system and method are provided. Included in the system is an array of energy signal transmitters mounted on a vehicle for transmitting signals within multiple transmit zones incrementally spaced from the vehicle. The system further includes an array of receiver elements mounted on the vehicle for receiving signals reflected from an object located in one or more multiple receive zones indicative of the object being in certain one or more zones. The system also includes a processor for processing the received reflected signals and determining location, speed and direction of the object, wherein the processor further determines whether the object is expected to impact the vehicle as a function of the determined location, speed and direction of the object, and generates an output signal indicative of a pre-impact event.

### TECHNICAL FIELD

The present application generally relates to vehicle crash sensing and, more particularly, relates to a system and method of sensing an imminent collision of an object with a vehicle prior to impact.

### BACKGROUND OF THE INVENTION

Automotive vehicles are commonly equipped with passenger restraint and crash mitigation devices such as seat belts, front air bags, side air bags and side curtains. These and other devices may be employed in the event of a collision with the vehicle to mitigate adverse effects to the vehicle and the occupants in the vehicle. With respect to activated devices, such as air bags and side curtain bags, these devices must be deployed quickly and in a timely fashion. Typically, these devices are deployed when sensors (e.g., accelerometers) mounted on the vehicle sense a severe impact with the vehicle.

In some vehicle driving situations, it is desirable to determine the onset of a collision, prior to impact of an object with the vehicle. For example, vision systems deploying cameras may be employed to monitor the surrounding environment around the vehicle and the video images processed to determine if an object appears to be on a collision with the vehicle. However, visions systems are generally very expensive and suffer a number of drawbacks.

It would be desirable to provide for an alternate effective system that senses a collision prior to impact with the vehicle, particularly for use to detect side impact events.

### SUMMARY OF THE INVENTION

According to one aspect of the present invention, a vehicle pre-impact sensing system is provided. The system includes a signal transmitter mounted on a vehicle for transmitting signals within multiple transmit zones incrementally spaced from the vehicle. The system also includes a receiver mounted on the vehicle for receiving signals reflected from an object located in the one or more multiple receive zones indicative of the object being in certain one or more receive zones. The system further includes a processor for processing the received reflected signals and determining location, speed and direction of the object. The processor further determines whether the object is expected to impact the vehicle as a function of the determined location, speed and direction of the object, and generates an output indicative of a sensed pre-impact event.

According to another aspect of the present invention, a vehicle pre-impact sensing system is provided that includes an array of energy signal transmitters mounted on a vehicle for transmitting signals within multiple transmit zones incrementally spaced from the vehicle, The system further includes an array of receiver elements mounted on the vehicle for receiving signals reflected from an object located in one or more multiple receive zones indicative of the object being in certain one or more receive zones. The system also includes a processor for processing the received reflected signals and determining location, speed and direction of the object. The processor further determines whether the object is expected to impact the vehicle as a function of the determined location, speed and direction of the object, and generates an output signal indicative of a sensed pre-impact event.

According to a further aspect of the present invention, a method of detecting an expected impact of an object with a vehicle is provided. The method includes the steps of transmitting a signal within multiple transmit zones incrementally spaced from the vehicle, one zone at a time, receiving signals reflected from an object located in the one or more multiple receive zones indicative of the object being in certain one or more zones, and processing the received reflected signals. The method also includes the steps of determining location of the object, determining speed of the object, and determining direction of the object. The method further includes the steps of determining whether the object is expected to impact the vehicle as a function of the determined location, speed and direction of the object, and generating an output signal indicative of a pre-impact event.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a side perspective view of a vehicle employing a pre-impact crash sensing system, according to a first embodiment of the present invention;

FIG. 2 is a rear view of the vehicle showing IR detection zones of the crash sensing system of FIG. 1;

FIG. 3 is an enlarged view of the IR transmitter and receiver arrays employed in the crash sensing system of FIG. 1;

FIG. 4 illustrates a block diagram of the pre-impact crash sensing system, according to the first embodiment;

FIG. 5 is a flow diagram illustrating a routine for sensing a pre-impact collision of an object with a vehicle, according to the first embodiment;

FIG. 6 is a schematic diagram illustrating an enlarged view of the IR transmitter and receiver arrays employed in a crash sensing system, according to a second embodiment of the present invention;

FIG. 7 is a side perspective view of a vehicle employing the crash sensing system, according to the second embodiment of the present invention;

FIG. 8 is a side perspective view of the vehicle further illustrating the receiver coverage zones, according to the second embodiment;

FIG. 9 is a side perspective view of a vehicle employing a pre-impact crash sensing system, according to a third embodiment of the present invention;

FIG. 10 is an enlarged view of the transmitter and receiver arrays employed in the crash sensing system of FIG. 9;

FIG. 11 is a block diagram of the pre-impact crash sensing system, according to the third embodiment; and

FIG. 12 is a flow diagram illustrating a routine for sensing a pre-impact collision of an object with a vehicle, according to the third embodiment.

### DESCRIPTION OF THE PREFERRED EMBODIMENTS

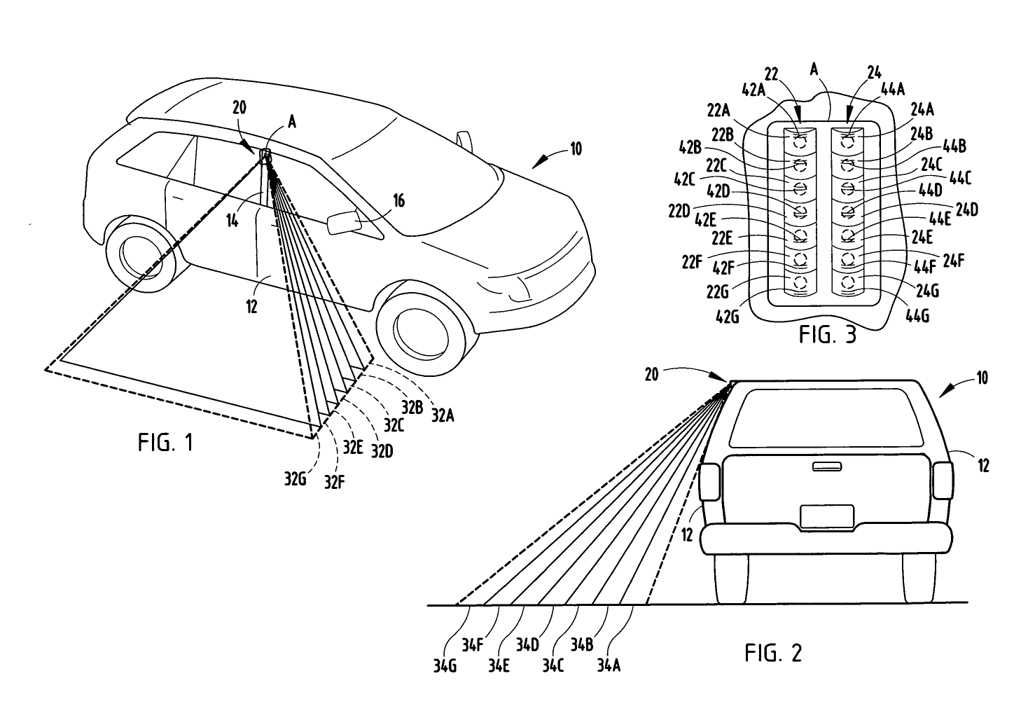

Referring to FIGS. 1-5, a vehicle pre-impact crash sensing system 20 is generally illustrated employed on a vehicle 10, according to a first embodiment. The crash sensing system 20 is shown and described herein configured to detect a pre-impact collision of an object (e.g., another vehicle) with the vehicle 10, particularly towards one or both lateral sides 12 of the vehicle 10. However, it should be appreciated that the crash sensing system 20 may be employed to detect a pre-impact event on any side of the vehicle 10, including one or both lateral sides, the front side and the rear side.

The vehicle 10 is generally shown as an automotive wheeled vehicle having opposite lateral sides 12, a B-pillar 14, and exterior side view mirror housings 16. In the first embodiment, the crash sensing system 20 generally includes an infrared (IR) transmitter array 22 and a detector array 24, shown mounted generally in the B-pillar 14 of the vehicle 10, at a position at or near the top of the vehicle 10 at a vantage point sufficient to detect objects located adjacent to a lateral side 12 of the vehicle 10. While the transmitter array 22 and receiver array 24 are shown mounted in the B-pillar, it should be appreciated that the transmitter array 22 and receiver array 24 may be located at other locations on the vehicle 10 and positioned to detect one or more objects in the desired vicinity of the vehicle 10.

As seen in FIG. 1, the transmitter array 22 transmits infrared (IR) energy signals within designated transmit beam patterns 32A-32G incrementally spaced from the lateral side 12 of the vehicle 10. The infrared transmitter array 22 has a plurality (e.g., seven) of infrared transmitters 22A-22G for transmitting infrared radiation signals within designated corresponding transmit zones 32A-32G. The transmitter array 22 is activated to sequentially transmit infrared radiation signals from one zone to the next zone at a high rate of speed, e.g., less than ten milliseconds. In the embodiment shown, the IR transmit zones 32A-32G extend from the upper side of B-pillar 14 of the vehicle 10 toward the road side ground on a lateral side 12 on the vehicle 10 and sequentially fan outward away from the lateral side 12 of the vehicle 10. Each IR transmit zone 32A-32G has a width sufficient to cover the intended detection zone at the lateral side 12 of the vehicle 10 and has a depth of a predetermined angle, such as five degrees. Thus, an array of seven transmitter elements may cover an angular depth of about thirty-five degrees.

The crash sensing system 20 also includes a receiver array 24 having a plurality of receiver elements, such as seven receiver elements 24A-24G. In the first embodiment, the receiver elements 24A-24G receive infrared radiation signals within IR corresponding receive zones 24A-24G which include infrared radiation signals reflected from an object within the corresponding IR receive zone. In the first embodiment, the receive zones 24A-24G are arranged in an array and are substantially aligned with the IR transmit zones 32A-32G.

In operation, the transmitter array 22 transmits infrared radiation signals within the IR transmit zones 32A-32G, one zone at a time, resulting in the transmission of sequential IR signals to the transmit zones, while the receiver array 24 receives reflected infrared radiation signals from objects located within the corresponding IR receive zones 34A-34G. By knowing which one of the IR transmit zones 32A-32G is illuminated with infrared radiation at a given point in time, the location of the detected object can be determined. As the object moves, the progression of the object through multiple zones can be monitored to determine speed and direction of the object, such that a processor may determine whether a pre-impact event of the object with the vehicle 10 is detected.

With particular reference to FIG. 3, the IR transmitter array 22 and receiver array 24 are illustrated according to one embodiment. The IR transmitter array 22 is shown having an array of seven IR light emitting diodes (LEDs) 22A-22G disposed behind respective beamforming optics 42A-42G, which may include reflecting and/or refracting optical elements or an aperture for defining a rectangular beam pattern. It should be appreciated that the IR transmitter array 22 may employ any of a number of signal transmitting elements for illuminating multiple transmit zones, and may be configured in any of a number of shaped and sized beam patterns. According to one example, the IR LEDs 22A-22G may employ a central wavelength of about 850 nanometers. One example of a commercially available IR LED is available from OSRAM Opto Semiconductors Inc., sold under the brand name Golden Dragon.

The IR receiver array 24 is shown employing seven photodetectors 24A-24G generally placed behind receiving lenses 44A-44G, respectively. The receiving lenses 44A-44G which may include reflecting and/or refracting optical elements that focus the reflected infrared radiation received from the corresponding IR receive zones 34A-34G onto the photodetectors 24A-24G, respectively. The receiver array 24 may employ any number of a plurality of receiver elements for receiving reflected IR signals from objects within the corresponding number of receive zones and may be configured with a rectangular shape or other shapes and sizes. One example of a photodetector is light-to-frequency converter commercially available from Texas Advanced Optoelectronic Solutions (TAOS).

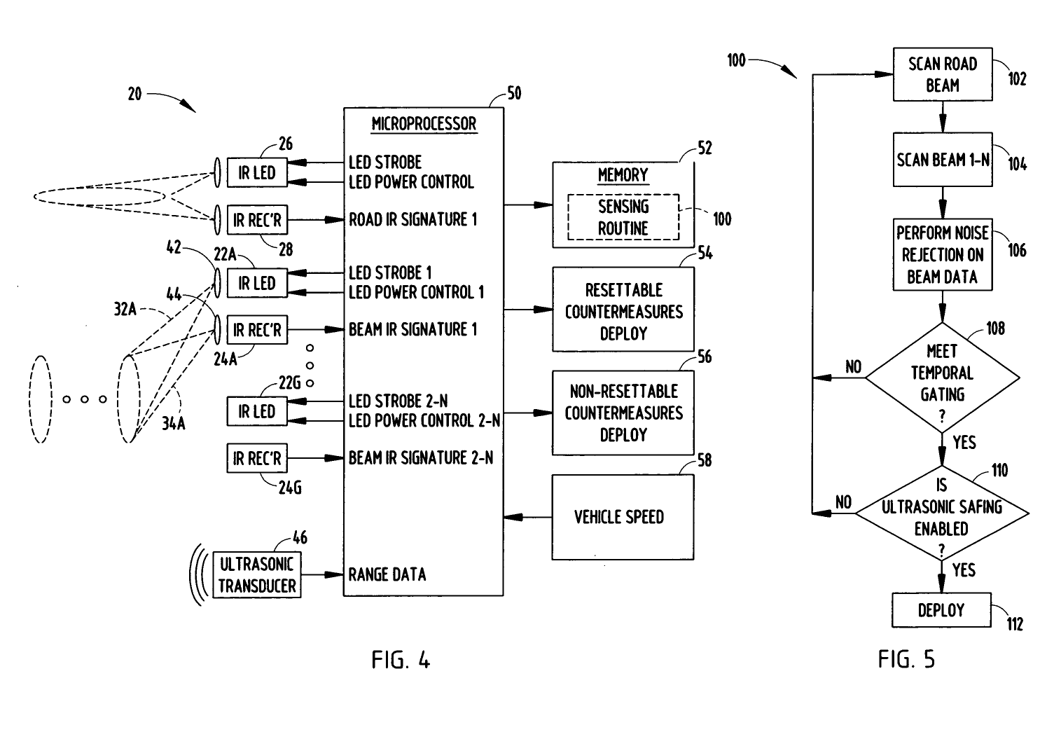

Referring to FIG. 4, the crash sensing system 20 is further illustrated employing a microprocessor 50 having various inputs and outputs. In addition to the IR transmitter array 22 and receiver array 24, the crash sensing system 20 may employ an additional infrared LED 26 and infrared receiver 28 for emitting IR radiation onto the road surface adjacent the lateral side of the vehicle 10 and receiving IR reflected signals therefrom. According to other embodiments, multiple IR LEDs and receivers may be employed to detect road surface contrast variations. This enables the detection of road images, such as paint and shadow and color variations, so as to further prevent false detections. The microprocessor 50 outputs LED strobe signals to the IR LED 26 and the IR LEDs 22A-22G of the transmitting array 22. Signals indicating reflected infrared radiation received by each receiver element are input to the microprocessor 50.

In addition, an ultrasonic transducer 46 provides an input to the microprocessor 50 to provide range data. The ultrasonic transducer 46 may be pointed in the lateral direction from the vehicle door trim or downward from the upper B-pillar, according to one embodiment. The ultrasonic transducer 46 may be employed as a safing input that may be logically ANDed with a processor generated output signal to provide risk mitigation for high target certainty. Alternatively, the crash detection system 20 may employ radar or heat detectors, such as a thermal IR detector that detects thermal energy.

The crash sensing system 20 further includes memory 52, including volatile and/or non-volatile memory, which may be in the form of random access memory (RAM), electrically erasable programmable read-only memory (EEPROM) or other memory. Stored within the memory 52 is a sensing routine 100 for processing the sensed data and determining a pre-impact event as described herein. Additionally, microprocessor 50 provides a resettable countermeasure deploy output signal 54 and a non-resettable countermeasure deploy output signal 56. The countermeasure deploy output signals 54 and 56 may be employed to mitigate the effects of an anticipated collision. Examples of countermeasure deploy activity may include deploying a pretensioner for one or more seat belts, deploying one or more air bags and/or side air bag curtains, controlling an active suspension or other vehicle dynamics adjustment, or further may activate other countermeasures on board the vehicle 10. Further, the microprocessor 50 receives vehicle speed 58.

The sensing routine 100 is illustrated in FIG. 5 for sensing an anticipated near impact event of an object with the vehicle. Routine 100 begins at step 102 to scan the road beam to detect road images, and then proceeds to step 104 to scan beams 1 through N, where N represents the number of coverage zones. This occurs by sequentially applying IR radiation within each of the beam patterns 1 through N and receiving reflected IR signals from the receive zones 1 through N. Next, routine 100 performs noise rejection on the beam data that is received. In decision step 108, routine 100 determines if the temporal gating has been met and, if not, returns to step 102. The temporal gating bracketing requirements may take into consideration the path, trajectory and rate of the object, the number of pixels of area, the inferred mass/volume/area, the illumination consistency, and angular beam spacing consistency.

According to one embodiment, temporal gating requirements are determined based on comparison of an object's perceived motion (detection from one contiguous zone to another) across the coverage zones to the expected relative speed of potential collision objects of interest (e.g., an automotive vehicle moving at a closing speed of 10 to 65 kilometers per hour (kph) or 6 to 40 miles per hour (mph) to a host vehicle's lateral side). The “range rate” of distance traveled per unit time of a potential collision object can be determined by the detection assessment of contiguous observation zones for range rates consistent with an expected subject vehicle's closing speed (i.e., if an object is detected passing through the observation zones at a rate of 1 observation zone per 70 milliseconds and each observation zone is 0.3 meters in length perpendicular to the host vehicle's lateral side, then the closing speed or range rate is approximately 4 meters per second, and is equivalent to approximately 15 kph or 10 mph). Objects moving at range rates slower or faster than the expected range rate boundary through the observation zones would not pass the temporal gating requirement.

Additional assessment can be made based on the quality of the received signal of a potential object as it passes through the observation zones. If the amplitude of the detected signal varies substantially from one contiguous observation zone to another (even if all signals are above a threshold value), it could indicate an off-axis collision trajectory or perhaps an object with a mass not consistent with a vehicle. The signal fidelity and consistency through the contiguous observation zones can be used to verify a potential vehicle collision.

If the temporal gating has been met, routine 100 then proceeds to decision step 110 to determine if the ultrasonic safing has been enabled and, if not, returns to step 102. If the ultrasonic safing has been enabled, routine 100 proceeds to deploy an output signal indicative of a sensed pre-impact event in step 112. The output signal may be employed to activate deployment of one or more countermeasures.

The crash sensing system 20 creates a three-dimensional space extending from the lateral size 12 of the vehicle 10 by way of a series of high speed illuminated and scanned infrared light signals provided in angularly offset curtains toward the side of the vehicle 10. Objects which appear within the window are scanned, and their location, speed, and direction are determined. In addition, the size of the object may be calculated. Further, the shape of the object may further be calculated. The processor processes the information in addition to vehicle speed, and determines whether or not a detected object is expected to impact the vehicle 10. The processor 50 processes the location of the object, speed of the object, and direction of the object in relation to the vehicle and the vehicle speed. Additionally, the processor 50 may further process the size and shape of the object in order to determine whether the object will likely collide with the vehicle and, whether the object is of a sufficient size to be a concern upon impact with the vehicle. If the object is determined to be sufficiently small or moving at a sufficiently slow rate, the object may be disregarded as a potential crash threat, whereas a large object moving at a sufficiently high rate of speed toward the vehicle would be considered a crash threat.

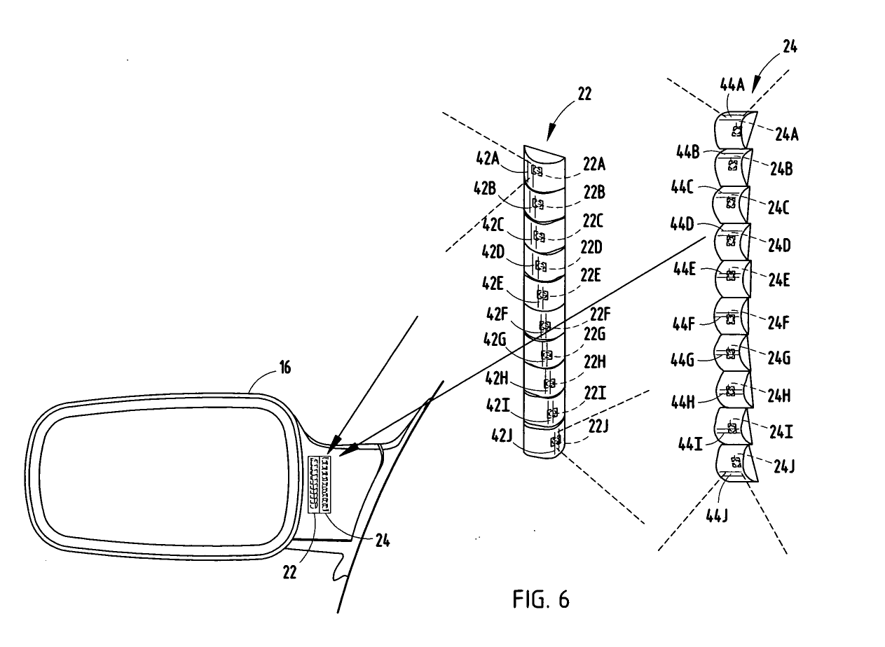

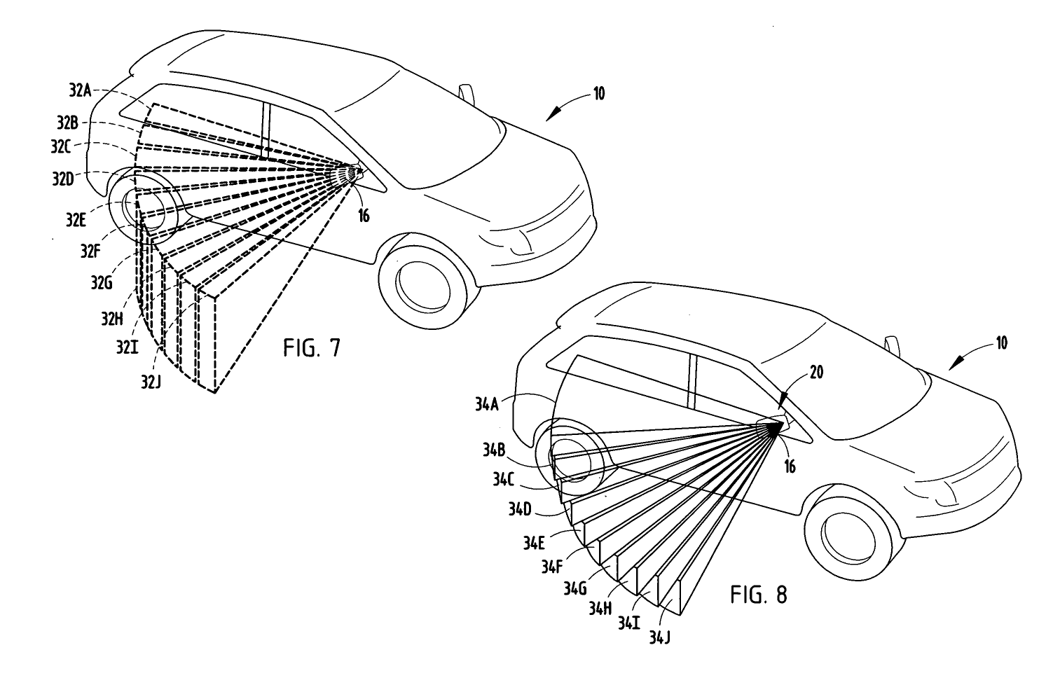

Referring to FIGS. 6-8, a pre-impact crash sensing system 20 is illustrated for use on a vehicle according to a second embodiment of the present invention. In the second embodiment, the crash sensing system 20 is shown employing a transmitter array 22 and receiver array 24 located on the exterior side rearview mirror housing 16 in a position that allows IR transmit beams to be transmit and reflected signals received in a series of curtains or fans. As seen in FIG. 7, the IR transmitter array 22 sequentially generates infrared signals within a plurality of transmit zones 32A-32J, one zone at a time, which extend vertically and generally in series on the lateral side 12 of vehicle 10 in a fan shape going away from the vehicle. According to one example, the ten transmit zones 32A-32J may extend from immediately adjacent the side of the vehicle to four feet from the vehicle and may provide individual beams each at five degrees and offset by five degrees to provide a total angular coverage zone of fifty degrees. The IR transmitter array 22, as seen in FIG. 6, includes ten IR LEDs 22A-22J and has lenses 42A-42J which may include reflecting and/or refracting optical elements, respectively, for focusing the infrared signals within the predefined beam coverage zones 32A-32J. Each of the lenses 42A-42J provides an offset focus feature of five degrees such that the transmit beam coverage from adjacent LEDs 22A-22J is offset five degrees relative to adjacent ones.

The receiver array 24 employs ten phototransistors 24A-24J and ten corresponding focus lenses 44A-44J. In contrast to the first embodiment, the receive zones 34A-34J are oriented at an angle relative to the transmit zones 32A-32J, such that the individual transmit and receive zones do not substantially overlap in complete beam coverage. As seen in FIG. 6, the lens 44A-44J provides for a substantially horizontal beam pattern, as compared to the vertical beam pattern provided by lenses 42A-42J of the transmitter array 22. By transmitting IR radiation sequentially in one of a plurality of vertical rectangular beams and receiving reflected IR radiation in substantially horizontal received zones, the crash sensing system 20, according to the second embodiment, is able to accurately determine which portion of transmit zones 32A-32J and which portion of receive zones 34A-34J a detected object is located within. This in part is because one transmit zone is illuminated at a given time.

The crash sensing system 20 according to the second embodiment may employ the same or similar hardware and routine 100 illustrated in FIGS. 4 and 5. In addition, the crash sensing system 20 according to the second embodiment may further process the accurate location data and better determine the trajectory of a detected object as it passes toward or away from the lateral side 12 of the vehicle 10. By monitoring the changes in position of an object over time, the speed and directivity of the object may be determined.

In operation, the crash sensing system, according to the second embodiment of the present invention, operates by sequentially illuminating one of the plurality of transmitter elements 22A-22J of transmitter array 22 so as to illuminate the transmit zones 32A-32J one at a time. The transmitter array 22 sequences in series amongst the IR LEDs 22A-22J at a very high rate of speed, such as less than ten milliseconds, to sequentially generate vertical illumination fans to illuminate any objects located within the transmit zones 32A-32J. If an object is present in one of the transmit zones, the object is illuminated and, the object is detected in one or more of the receive zones. The illuminated object is detected by the IR signals being reflected and picked up by the receiver array 24. The receiver array 24 determines which receive zone 34A-34J the object is located in based on which zone was illuminated and which zone the reflected signal was detected in. It should be appreciated that each of the ten IR LEDs 24A-24J are arranged to view the entire scanned area in horizontal bands such that the crash sensing system 20 is able to better evaluate any changes in motion of the object as it passes from one zone distant from the vehicle towards another zone closer to the vehicle. Based on the object location, speed, directivity, and vehicle speed, the processor 50 is able to determine whether the object is likely to impact the vehicle 10.

The fan arrangement of the transmit signals in the transmit zones 32A-32J and the receive zones 34A-34J may vary depending upon the vehicle. Requirements for the transmitted signals within the fan strip closest to the vehicle may vary depending on shape and size of the vehicle and may vary from one vehicle platform to another. In particular, the nearest curtain towards the vehicle may require a larger variation in the beam shape. In order to accommodate for variations, a segmented lens design may be utilized to provide design flexibility for customized curtain fan shapes. One example of a segmented lens is disclosed in U.S. patent application Ser. No. 11/732,296, filed on Apr. 3, 2007 and entitled “SYNCHRONOUS IMAGING USING SEGMENTED ILLUMINATION,” the entire disclosure of which is herein incorporated herein by reference.

It should be appreciated that a complete field image may be generated every tenth scan of the covered volume. By comparing subsequent images, the size and shape of an incoming object can be determined. To aid in the evaluation of the distance of the object from the lens system, a couple of methods may be utilized. One method may employ a calibration illumination band which dissects the first ten illumination fans. The calibration fan may be multiplexed in with the other illumination fans. By employing triangulation, the presence of an object in the zone fans 1-10 versus the calibration fan relative to the distance can be determined. A second method may use the reflection power of the object. The IR transmitter power may be modulated with a signal to allow differentiation from ambient light. This power including modulation may be gain adjusted with feedback from the ten light receivers such that the power index is developed. The power index is directly related to the distance of the object and the fixed reflectance. For each infrared transmitter illumination, each receiver signal may be evaluated for signal strength. In this way, each frame of data may take one hundred measurements for example. The microprocessor 50 would process this frame and subsequent frames for size, shape and trajectory information.

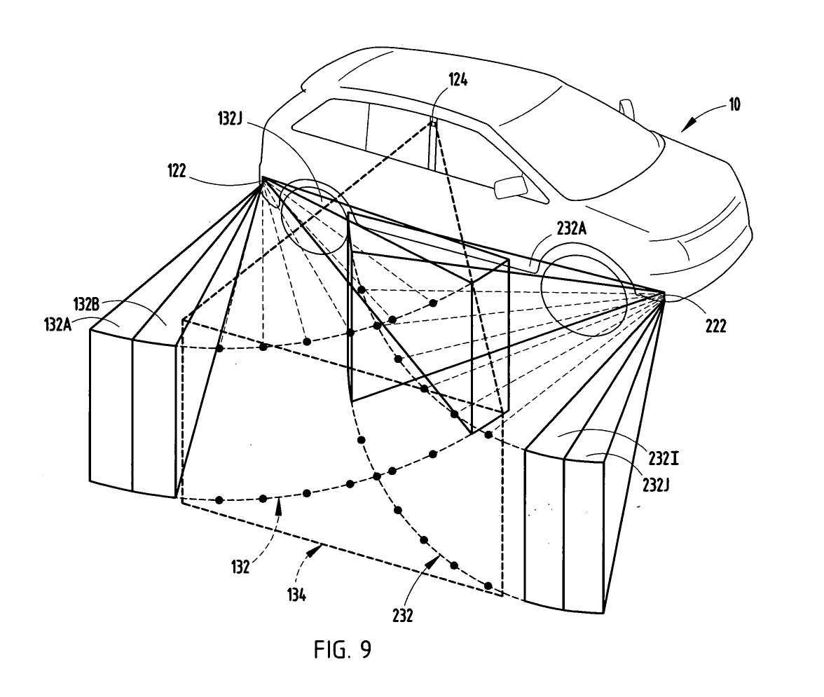

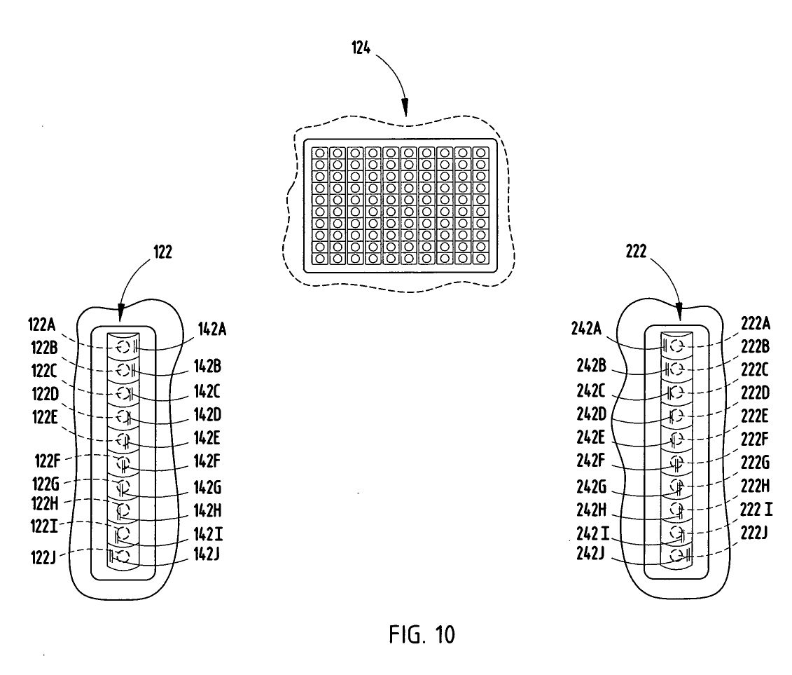

Referring to FIGS. 9-12, a pre-impact crash sensing system 20 is illustrated on a vehicle 10, according to a third embodiment of the present invention. In contrast to the first and second embodiments, the crash sensing system 20 of the third embodiment employs two transmitter arrays 122 and 222 and a receiver array 124 made up of a ten by ten (10×10) array of receiver elements, such as photodetectors (e.g., phototransistors). The first IR transmitter 122 is shown located near the rear bumper on a lateral side 12 of the vehicle 10 and facing forward, whereas the second IR transmitter array 222 is located near the front bumper on the same lateral side 12 of the vehicle 10 and facing rearward. The first IR transmitter array 122 includes ten IR LEDs 122A-122J for illuminating IR radiation signals within respective vertical transmit zones 132A-132J, respectively, one zone at a time. Likewise, the second IR transmitter 222 includes an array of ten IR LEDs 222A-222J for sequentially illuminating ten respective vertical transmit zones 232A-232J, one zone at a time.

The IR receiver array 124 is made up of a ten by ten (10×10) array of IR phototransistors, each of which covers a portion of an imaging field to detect reflected IR signals from objects that were illuminated with at least one of the first and second transmitter arrays 122 and 222. In the embodiment shown, the IR receiver 224 is located near the top of the B-pillar of the vehicle and positioned to scan a volume to the side of the vehicle which at least partially overlaps with the transmit zones 132A-132J and 232A-232J. A volumetric measurement is performed by scanning the transmit zones to receive reflected IR radiation signals and determine the location, speed and trajectory in relation to the vehicle.

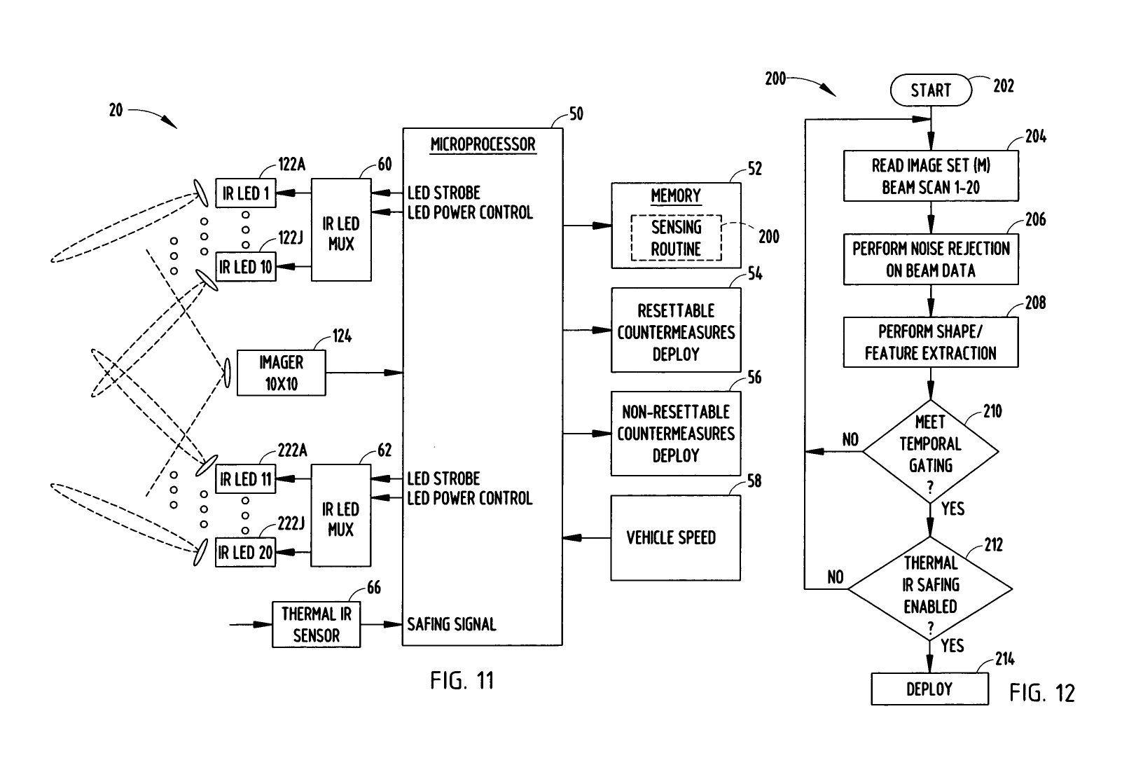

The pre-impact crash sensing system 20 according to the third embodiment, is further shown in FIG. 11. Included is a microprocessor 50 that communicates with the first and second transmitter arrays 122 and 222 by way of respective IR LED multiplexers (MUX) 60 and 62, respectively. The multiplexer enables the activation of individual IR LEDs. The imager or IR receiver 124 captures the reflected received IR signals and provides input signals to the microprocessor 50. Additionally, a thermal IR sensor 66 is shown for providing a safing signal as an input to the microprocessor 50.

The crash sensing system 20 according to the third embodiment of the present invention employs a sensing routine 200 stored in memory 52 and executed by microprocessor 50. The sensing routine 200 is further illustrated in FIG. 12 beginning at step 202 and proceeds to read the image set (M) beam scan 1-20 in step 204. Next, in step 206, routine 200 performs noise rejection on the beam data. The routine 200 then performs shape/feature extraction in step 208. In decision step 210, routine 200 determines if the temporal gating has been met and, if not, returns to step 204. If the temporal gating requirement has been met, routine 200 proceeds to decision step 212 to determine if the thermal IR safing is enabled and, if not, returns to step 204. If the thermal IR safing is enabled, routine 200 proceeds to step 214 to deploy the output signal.

The temporal gating requirement of decision step 210 may include processing the path, trajectory and rate of the object detected. In addition, the number of pixels of the area may be considered. Further, an inferred mass/volume/area is taken into consideration. The illumination consistency and the angular beam spacing consistency are further considered as part of the temporal gating requirement.

The step 208 of performing shape/feature extraction in step 208 may apply traditional image processing techniques, such as contrast enhancement, contrast threshold, histogram, stretch and suppression heuristics, and/or bilinear interpolation to extract shape and feature primitives for evaluation and assessment of potential impending side impact.

According to the third embodiment, the crash sensing system uses multiple IR transmitters and vertical fans at two different locations and a receiver then employs a larger array of discrete receiver elements to better evaluate objects as they approach the vehicle. Scanning can be performed by multiplexing the twenty infrared transmitters individually while monitoring the one hundred receiver elements in the exemplary embodiment. A complete frame may include two thousand data points, according to one example. In one example, frame times may be desired at less than ten milliseconds which is feasible with moderate computing power.

Accordingly, the pre-crash sensing system 20 of the present invention advantageously detects an impending collision of an object with the vehicle 10, prior to the actual collision. The crash sensing system 20 is cost affordable and effective to determine whether an object is approaching the vehicle 10 and may collide with the vehicle, sufficient to enable a determination of the impending collision prior to actual impact. Further, the pre-crash sensing system 20 may determine whether the object is of sufficient size and speed to deploy certain countermeasures.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A vehicle pre-impact sensing system comprising:
a signal transmitter mounted on a vehicle for transmitting signals within multiple transmit zones incrementally spaced from the vehicle;
a receiver mounted on the vehicle for receiving said signals reflected from an object located in one or more of the multiple receive zones indicative of the object being in certain one or more zones; and
a processor for processing the received reflected signals and determining location, speed and direction of the object, wherein the processor further determines whether the object is expected to impact the vehicle as a function of the determined location, speed and direction of the object, and generates an output indicative of a sensed pre-impact event.

2. The sensing system as defined in claim 1, wherein the processor further determines size of the object, wherein the processor generates an output signal indicative of the sensed pre-impact event further based on the determined size of the object.

3. The sensing system as defined in claim 1, wherein the signal transmitter comprises a light transmitter.

4. The sensing system as defined in claim 3, wherein the light transmitter comprises an infrared transmitter.

5. The sensing system as defined in claim 1, wherein the signal transmitter comprises an array of infrared emitters each configured to emit infrared radiation in a designated one of the multiple transmit zones.

6. The sensing system as defined in claim 5, wherein the receiver comprises an array of multiple photodetectors for receiving reflected infrared radiation, wherein the photodetectors receive reflected signals from designated receive zones.

7. The sensing system as defined in claim 6, wherein the array of emitters emit transmit signals in first transmit zones and the array of multiple photodetectors receive the reflected signals from within multiple receive zones, wherein the transmit zones are oriented at an angle relative to the receive zones.

8. The sensing system as defined in claim 6, wherein the array of emitters emit the signals in first transmit zones and the array of multiple photodetectors receive reflected signals within multiple receive zones, wherein the transmit zones are substantially aligned with the receive zones.

9. The sensing system as defined in claim 1, wherein the transmitter incrementally emits light signals in the multiple zones, one zone at a time.

10. The sensing system as defined in claim 1, wherein the system senses an object on a lateral side of the vehicle.

11. The sensing system as defined in claim 1, wherein the receiver is mounted on one of the B-pillar, an exterior mirror housing and vehicle bumper.

12. A vehicle pre-impact sensing system comprising:
an array of energy signal transmitters mounted on a vehicle for transmitting signals within multiple transmit zones incrementally spaced from the vehicle;
an array of receiver elements mounted on the vehicle for receiving the signals reflected from an object located in one or more multiple receive zones indicative of the object being in certain one or more receive zones; and
a processor for processing the received reflected signals and determining location, speed and direction of the object, wherein the processor further determines whether the object is expected to impact the vehicle as a function of the determined location, speed and direction of the object, and generates an output signal indicative of a sensed pre-impact event.

13. The sensing system as defined in claim 12, wherein the processor further determines size of the object, wherein the processor generates an output signal indicative of the sensed pre-impact event further based on the determined size of the object.

14. The sensing system as defined in claim 12, wherein the array of transmitters comprises an array of infrared emitters each configured to emit infrared radiation in a designated one of the multiple transmit zones.

15. The sensing system as defined in claim 12, wherein the array of receiver elements comprises a plurality of photodetectors for receiving the reflected infrared signals.

16. The sensing system as defined in claim 12, wherein the system senses an object on a lateral side of the vehicle.

17. The sensing system as defined in claim 12, wherein the receiver is mounted on one of the B-pillar, an exterior mirror housing and vehicle bumper.

18. A method of detecting an expected impact of an object with a vehicle, said method comprising the steps of:
transmitting signals within multiple transmit zones incrementally spaced from the vehicle, within one zone at a time;
receiving signals reflected from an object located in the one or more multiple zones indicative of the object being in certain one or more receive zones;
processing the received reflected signals;
determining location of the object;
determining speed of the object;
determining direction of the object;
determining whether the object is expected to impact the vehicle as a function of the determined location, speed and direction of the object; and
generating an output signal indicative of a sensed pre-impact event.

19. The method as defined in claim 18 further comprising the steps of:
determining size of the object; and
generating the output signal indicative of the pre-impact event further based on the determined size of the object.

20. The method as defined in claim 18, wherein the step of transmitting signals comprises transmitting an infrared radiation signal via an array of infrared transmitters into the multiple transmit zones.

21. The method as defined in claim 20, wherein the step of receiving the signals comprises receiving reflected infrared radiation via an array of infrared receivers.

22. The method as defined in claim 21, wherein the transmitter and receiver are oriented generally on a lateral side direction of the vehicle to detect an object toward the lateral side of the vehicle.
